(19) United States
(12) Patent Application Publication
(10) Pub. No.: US 2003/0154971 A1
(43) Pub. Date: Aug. 21, 2003

(54) One-piece hood for an outdoor grill

(76) Inventor: Wayne Chapman, Greeneville, TN (US)

Correspondence Address: LUKE ANDERSON, McGuire Woods LLP, Bank of America Corporate Center, 100 North Tryon Street, Suite 2900, Charlotte, NC, 28202-4011, US

(21) Appl. No.: 10/294,472

(22) Filed: Nov. 14, 2002

Related U.S. Application Data
(63) Continuation-in-part of application No. 09/696,811, filed on Oct. 26, 2000.

(51) Int. Cl. F24C 3/00; A47J 37/00

(52) U.S. Cl. 126/41 R; 126/50

(57) ABSTRACT

A one-piece hood for a gas grill is formed from a single sheet of steel and comprises at least a front wall, a back wall, opposing side walls, and a top wall. Each of the opposing side walls further includes an indented central portion that has a substantially uniform depth and a perimeter internally adjacent to the side wall perimeter. The indented central portions increase the structural strength of the hood so as to better resist warping due to heating. A sloped wall can be formed between the top wall and the front wall. The hood is porcelain-coated to prevent rust.

### RELATIONSHIP TO PRIOR APPLICATIONS

This application is a continuation-in-part of application serial number 09/696,811, filed Oct. 26, 2000, now pending.

### FIELD OF THE INVENTION

The present invention is drawn to a one-piece hood for an outdoor grill. More particularly, the invention is to a gas grill that includes a one-piece hood formed with side recesses. Forming the hood in one-piece allows it to be made of steel and porcelain-coated to prevent rust. Additionally, the disclosed grill includes a contoured control panel and side tables that can be teardrop shaped.

### BACKGROUND INFORMATION

Prior art gas grills suffer from various deficiencies. Hoods on gas grills must usually be cast in a relatively costly manner in order to have sufficient strength to prevent warping due to heat. U.S. Pat. Nos. 4,989,579 to Murphy et al., D415,388 to Wagner et al., and D420,244 to Pai disclose the use of conventional stepped and angled ridges that are often incorporated into cast aluminum hoods in order to taper the hood for both material savings and better heat circulation (see column 3, line 66 to column 4, line 26 of Murphy et al.). FIG. 1 of U.S. Pat. No. 5,163,358 to Hanagan et al. discloses a similar ridge element depending vertically from the top wall and slanting to the front wall. These ridges inherently stiffen the walls against bending, but none of this art suggest the desirability of stiffening along the entire perimeter of a side wall.

U.S. Pat. Nos. D237,856 to Madson et al. and D229,660 to Gammon disclose hoods with semicircular side walls that are indented, but only adjacent to the curved upper portions of the walls. The “indentation” continues to the bottom edge to be coextensive with the bottom of the side wall perimeter and therefore not “adjacent” to the perimeter along that portion. Additionally, Madson et al. does not have an indentation of a substantially uniform depth and Gammon does not disclose a hood formed in one piece. As design patents, neither Madson et al. nor Gammon suggests any reasons or advantages of this design, beyond ornamentation.

Another type of grill hood is a three-piece hood that has a central portion forming the front, top and back walls joined to two end-sections forming the side walls. When made of steel, it is desirable to coat the sections to prevent rust. However, it can be difficult to coat the joints and/or prevent rust at the joints.

### BRIEF SUMMARY OF THE INVENTION

It is an object of the invention to provide an outdoor grill that includes a one-piece hood formed with side recesses that provide strength to resist warping under heating conditions.

It is an object of the invention to provide an outdoor grill that includes a one-piece hood formed of coated steel to prevent rust.

It is yet another object of the invention to provide a grill hood that is both durable and attractive, yet inexpensive to produce.

### BRIEF DESCRIPTION OF THE DRAWINGS

FIG. 1 illustrates a perspective view of the one-piece hood of the present invention in combination with a grill.

FIG. 2 illustrates a front view of the one-piece hood of the present invention in combination with a grill.

FIG. 3 illustrates a back view of the one-piece hood of the present invention in combination with a grill.

FIG. 4 illustrates a top view of the one-piece hood of the present invention in combination with a grill.

FIG. 5 illustrates a side view of the one-piece hood of the present invention in combination with a grill.

### DETAILED DESCRIPTION OF THE INVENTION

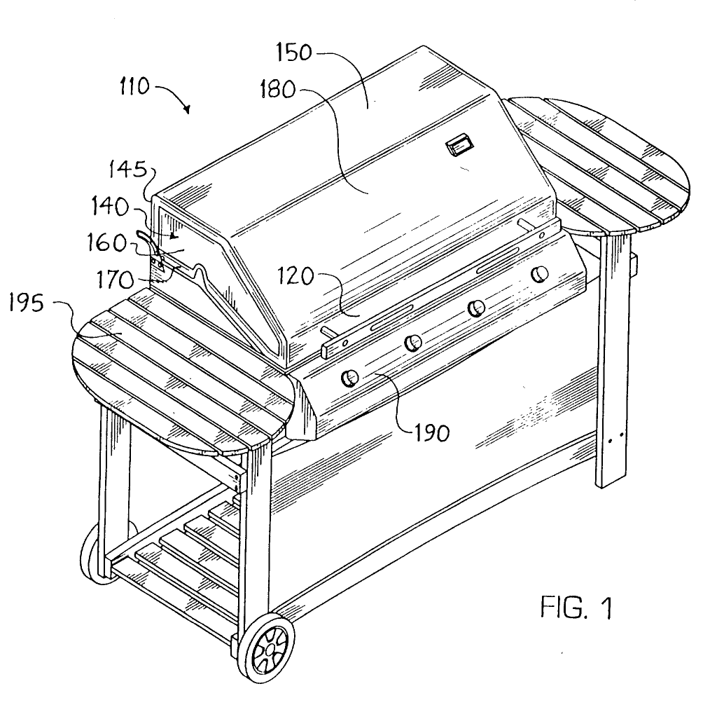

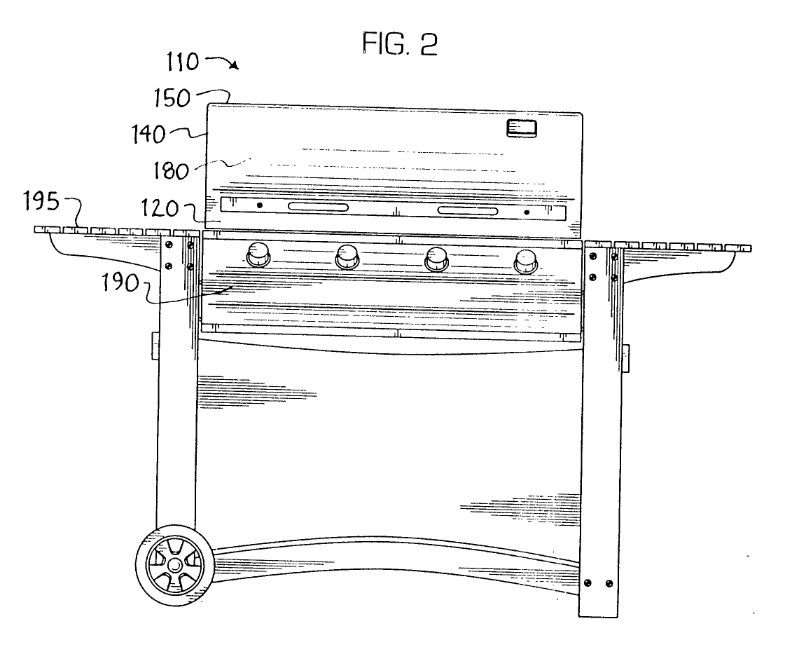

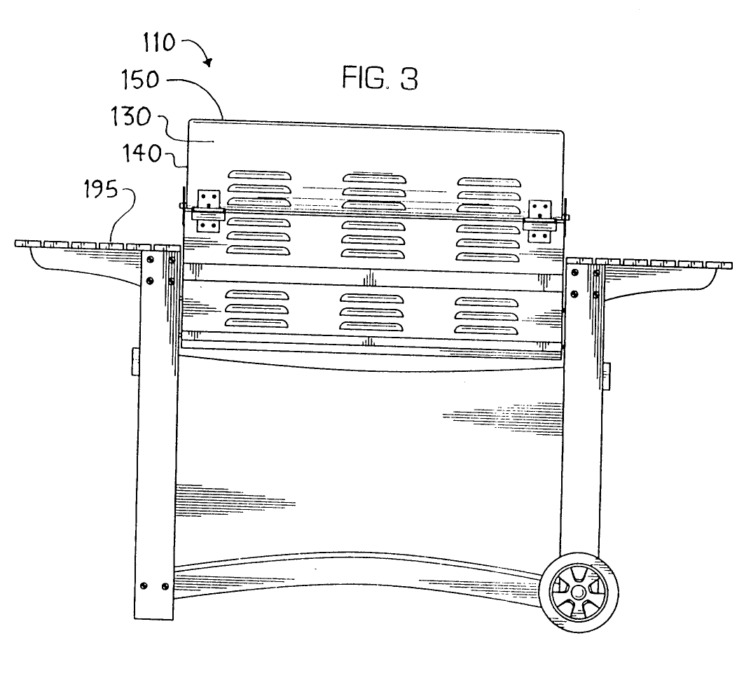

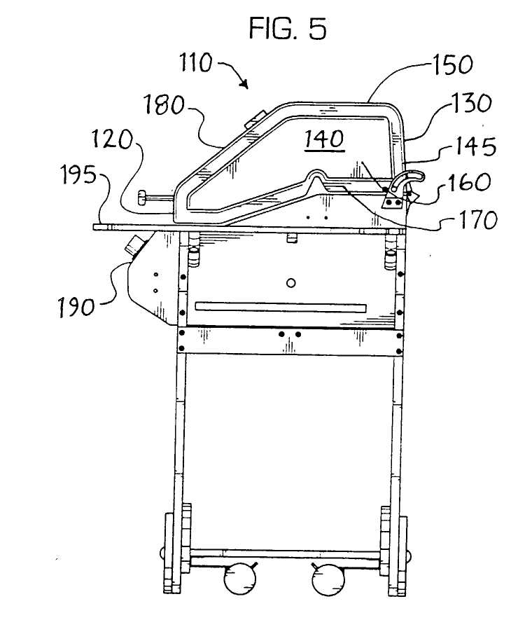

The present invention is a one-piece hood for gas grills that incorporates recesses or indentations in the side walls, as shown in FIGS. 1 through 5. It includes a one-piece hood for gas grills and a method of forming the hood from stamped steel. As shown in the attached figures, especially FIGS. 1 and 5, the hood is formed with recesses in the sides. The recesses add a great deal of strength to prevent twisting and flex under heated conditions. The one-piece gas hood apparatus invention is considered, at a minimum, to include:

A one-piece hood 110 for a gas grill comprising:

a front wall 120;

a back wall 130;

opposing side walls 140; and

a top wall 150,

wherein each of said opposing side walls 140 further comprises an indented central portion 160 having a substantially uniform depth and a perimeter 170 internally adjacent to the side wall 140 perimeter 145.

The one-piece gas hood method invention is considered, at a minimum, to include:

A method for forming a one-piece hood 110 for a gas grill comprising:

forming a front wall 120, a back wall 130, opposing side walls 140, and a top wall 150 as a single piece; and

forming an indented central portion 160 in each side wall, said indented central portion having a substantially uniform depth and a perimeter 170 internally adjacent to the side wall 140 perimeter 145.

The one-piece hood 110 can also include a slope-front wall 180 and is preferably formed from a single piece of steel.

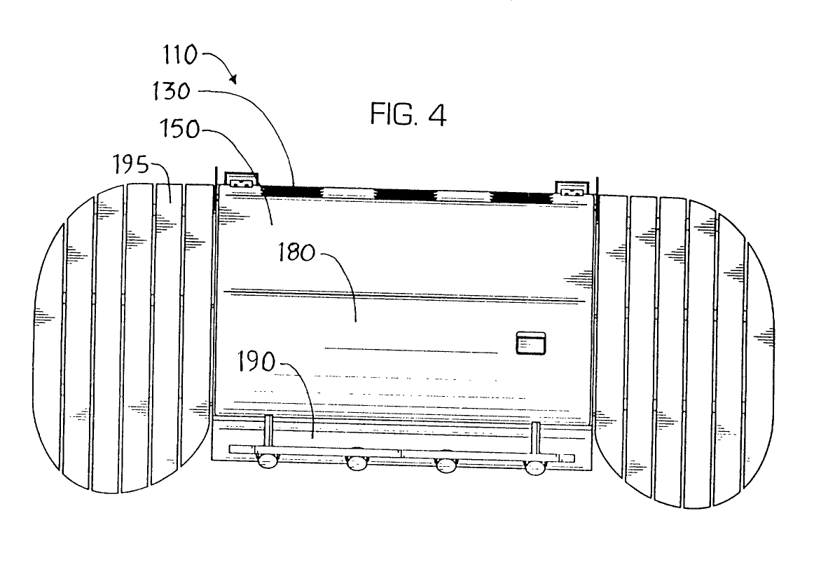

As shown most clearly in FIGS. 1, 2, and 5, the front control panel 190 of the grill can incorporate a contoured design. Additionally, as shown in FIGS. 1 and 4, the grill can also incorporate side tables 195 that have a “tear drop” shape.

In a preferred embodiment, the hood is painted or porcelain-coated to prevent rust and formed from approximately 0.05″ thick steel sheet by a deep draw forming process to provide recesses of a substantially uniform depth of about 0.04″.

Although exemplary embodiments have been disclosed herein, many other configurations within the scope of the present invention are possible, with the present invention being limited only by the appended claims.

We claim:

1. A one-piece hood for a gas grill comprising:
a front wall;
a back wall;
opposing side walls; and
a top wall, wherein each of said opposing side walls further comprises an indented central portion having a substantially uniform depth and a perimeter internally adjacent to the side wall perimeter.

2. The one-piece hood of claim 1, wherein a sloped-front wall is located between said top wall and said front wall.

3. The one-piece hood of claim 1, wherein said one-piece hood is formed from a single piece of steel.

4. The one-piece hood of claim 3, wherein said one-piece hood is coated to prevent rust.

5. The one-piece hood of claim 4, wherein said coating is porcelain.

6. A method for forming a one-piece hood for a gas grill comprising:
forming a front wall, a back wall, opposing side walls, and a top wall as a single piece; and
forming an indented central portion in each side wall, said indented central portion having a substantially uniform depth and a perimeter internally adjacent to the side wall perimeter.

7. The method for forming a one-piece hood of claim 6, wherein a sloped-front wall is formed between said top wall and said front wall.

8. The method for forming a one-piece hood of claim 6, wherein said one-piece hood is formed from a single piece of steel.

9. The method for forming a one-piece hood of claim 8, wherein said one-piece hood is coated to prevent rust.

10. The method for forming a one-piece hood of claim 9, wherein said one-piece hood is coated with porcelain.
